(19) United States
(12) Patent Application Publication
(10) Pub. No.: US 2004/0233834 A1
(43) Pub. Date: Nov. 25, 2004

(54) FLOATING-TYPE CLAMPING MECHANISM USED IN AN OPTICAL DISK DRIVE

(76) Inventor: Jui-Chiang Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,604

(22) Filed: May 18, 2004

(30) Foreign Application Priority Data
May 21, 2003 (TW) 092113780

(51) Int. Cl. G11B 5/10

(52) U.S. Cl. 369/292

(57) ABSTRACT

A floating-type clamping mechanism includes a clamping body, a clamping yoke including a first central hole, a central clamping element for combining with the clamping yoke by passing through the first central hole, a magnetic element including a second central hole for holding the central clamping element and combining with the clamping yoke, and a plurality of elastic elements fixed at the clamping body and a clamping yoke.

### BACKGROUND OF INVENTION

1. Field of the Invention

The present invention relates to an optical disk drive, and more particularly, to a floating-type clamping mechanism for use in an optical disk drive.

2. Description of the Prior Art

Recently owing to the progress of computer technology, reading speeds of optical disk drives are becoming faster. Optical disk drives read data on optical disks by optical principles. First an optical disk is held on a turntable of a motor of the optical disk drive by a clamping mechanism. The clamping mechanism can fix and release the optical disk precisely so that the optical disk can be positioned and ejected smoothly. So the clamping mechanism is a very important mechanism of the optical disk drive.

Please refer to FIG. 1. FIG. 1 is a perspective diagram of a fixing-type clamping mechanism 12 in the prior art. The fixing-type clamping mechanism 12 includes a clamping body 41, a magnetic element 42, and a clamping yoke 44. The magnetic element 42 can be combined with the clamping yoke 44, and then the combination of the magnetic element 42 and the clamping yoke 44 can be integrated into the clamping body 41. Please refer to FIG. 2 and FIG. 3. FIG. 2 is a top view of the fixing-type clamping mechanism 12 in the prior art. FIG. 3 is a bottom view of the fixing-type clamping mechanism 12 in the prior art. There is a need to reserve height for a central clamping element of the fixing-type clamping mechanism 12 to make sure that the fixing-type clamping mechanism 12 can be combined with the turntable precisely. This is a disadvantage in an optical disk drive having spatial limitations.

Please refer to FIG. 4. FIG. 4 is a sectional view of the fixing-type clamping mechanism 12 in the prior art. Please refer to FIG. 5 and FIG. 6. FIG. 5 is a top view of an attractive-type clamping mechanism 13 in the prior art. FIG. 6 is a bottom view of the attractive-type clamping mechanism 13 in the prior art. Please refer to FIG. 7. FIG. 7 is a perspective diagram of components of the attractive-type clamping mechanism 13 in the prior art. The magnetic element 42 and a central clamping element 43 and the clamping yoke 44 can be integrated, and then the combination of the magnetic element 42 and the central clamping element 43 and the clamping yoke 44 can be integrated into the clamping body 41. Please refer to FIG. 8. FIG. 8 is a sectional view of the attractive-type clamping mechanism 13 when the attractive-type clamping mechanism 13 does not fix an optical disk in the prior art. As shown, the attractive-type clamping mechanism 13 attracts a metal element 14 by the action of the magnetic element 42. FIG. 9 is a sectional view of the attractive-type clamping mechanism 13 when the attractive-type clamping mechanism 13 fixes an optical disk in the prior art. As shown, the attractive-type clamping mechanism 13 is attracted to a magnetic element on the turntable of the optical disk drive by the action of the magnetic element 42. As shown in FIG. 8, the metal element 14 is for being attracted by the attractive-type clamping mechanism 13 when the attractive-type clamping mechanism 13 does not fix an optical disk. Therefore height of the metal element 14 has to be reserved, and the cost will increase.

There is indeed a need to solve the above-mentioned disadvantages for reducing cost and utilizing the limited internal space of an optical disk drive effectively.

### SUMMARY OF INVENTION

It is therefore a primary objective of the claimed invention to provide a floating-type clamping mechanism for reducing the cost and utilizing the limited space in an optical disk drive effectively, to solve the above-mentioned problems.

According to the claimed invention, a floating-type clamping mechanism for use in an optical disk drive is proposed. The floating-type clamping mechanism includes a clamping body, a clamping yoke including a first central hole, a central clamping element for combining with the clamping yoke by passing through the first central hole, a magnetic element including a second central hole for holding the central clamping element and combining with the clamping yoke, and a plurality of elastic elements fixed to the clamping body and a clamping yoke.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a perspective diagram of a fixing-type clamping mechanism in the prior art.

FIG. 2 is a top view of the fixing-type clamping mechanism in the prior art.

FIG. 3 is a bottom view of the fixing-type clamping mechanism in the prior art.

FIG. 4 is a sectional view of the fixing-type clamping mechanism in the prior art.

FIG. 5 is a top view of an attractive-type clamping mechanism in the prior art.

FIG. 6 is a bottom view of the attractive-type clamping mechanism in the prior art.

FIG. 7 is a perspective diagram of components of the attractive-type clamping mechanism in the prior art.

FIG. 8 is a sectional view of the attractive-type clamping mechanism when the attractive-type clamping mechanism does not fix an optical disk in the prior art.

FIG. 9 is a sectional view of the attractive-type clamping mechanism when the attractive-type clamping mechanism fixes an optical disk in the prior art FIG. 10 is a diagram of an optical disk drive.

FIG. 11 is a top view of a floating-type clamping mechanism according to a first embodiment of the present invention.

FIG. 12 is a bottom view of the floating-type clamping mechanism according to the first embodiment of the present invention.

FIG. 13 is a perspective diagram of components of the floating-type clamping mechanism according to the first embodiment of the present invention.

FIG. 14 is a perspective diagram of the combination of a rabbet of the floating-type clamping mechanism and a clamping flange of a clamping holder.

FIG. 15 is a perspective diagram of the combination of the floating-type clamping mechanism and the clamping holder and a turntable for fixing an optical disk when the optical disk is loaded into the optical disk drive.

FIG. 16 is a perspective diagram of the combination of the floating-type clamping mechanism and the turntable.

FIG. 17 is a schematic diagram of components of the floating-type clamping mechanism when the optical disk is not loaded into the optical disk drive.

FIG. 18 is a schematic diagram of components of the floating-type clamping mechanism when the optical disk is loaded into the optical disk drive.

FIG. 19 is a top view of a floating-type clamping mechanism according to a second embodiment of the present invention.

FIG. 20 is a bottom view of the floating-type clamping mechanism according to the second embodiment of the present invention.

FIG. 21 is a perspective diagram of components of the floating-type clamping mechanism according to the second embodiment of the present invention.

FIG. 22 is a perspective diagram of the combination of the rabbet on the outer edge of the floating-type clamping mechanism and the clamping flange of the clamping holder according to the second embodiment of the present invention.

FIG. 23 is a perspective diagram of the combination of the floating-type clamping mechanism and the clamping holder and the turntable for fixing the optical disk when the optical disk is loaded into the optical disk drive of the second embodiment.

FIG. 24 is a perspective diagram of the combination of the floating-type clamping mechanism and the turntable according to the second embodiment of the present invention.

FIG. 25 is a schematic diagram of components of the floating-type clamping mechanism when the optical disk is not loaded into the optical disk drive according to the second embodiment of the present invention.

FIG. 26 is a schematic diagram of components of the floating-type clamping mechanism when the optical disk is loaded into the optical disk drive according to the second embodiment of the present invention.

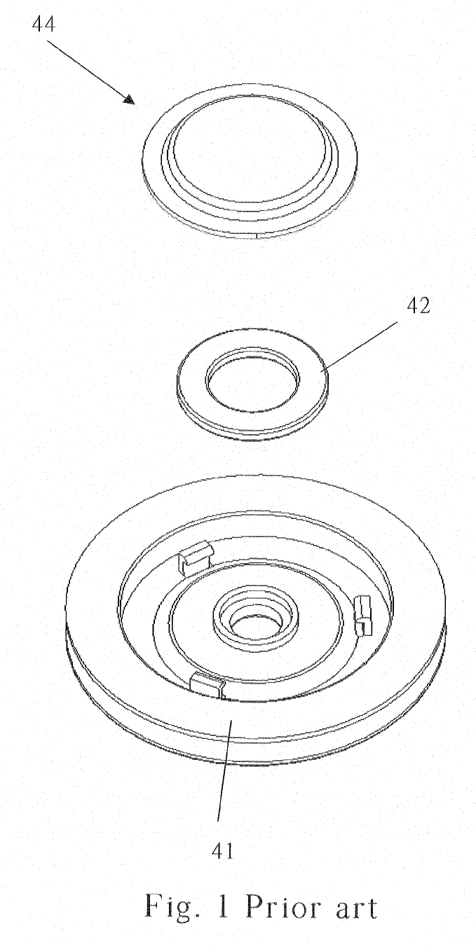

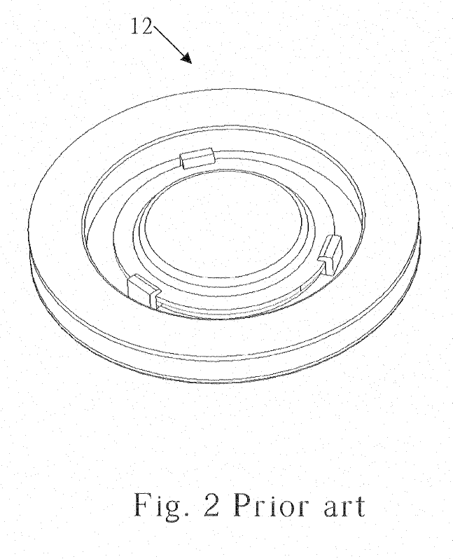

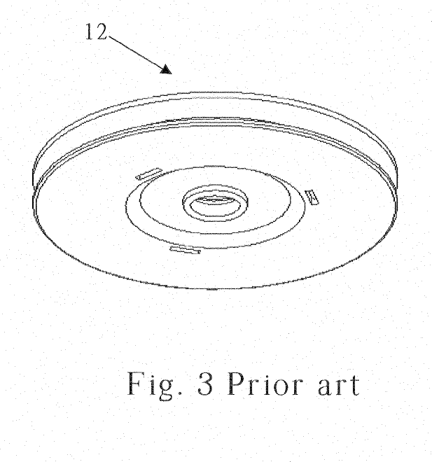

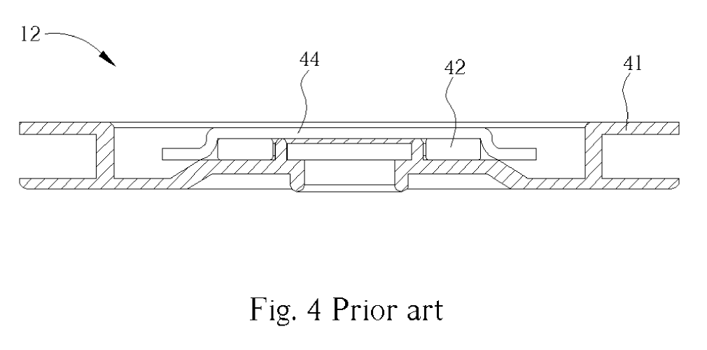

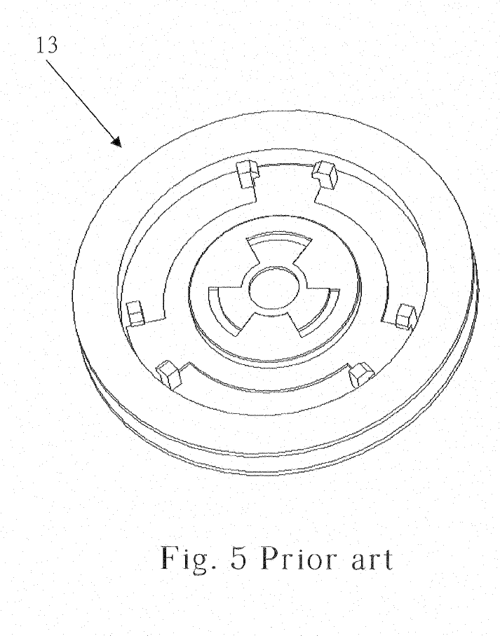

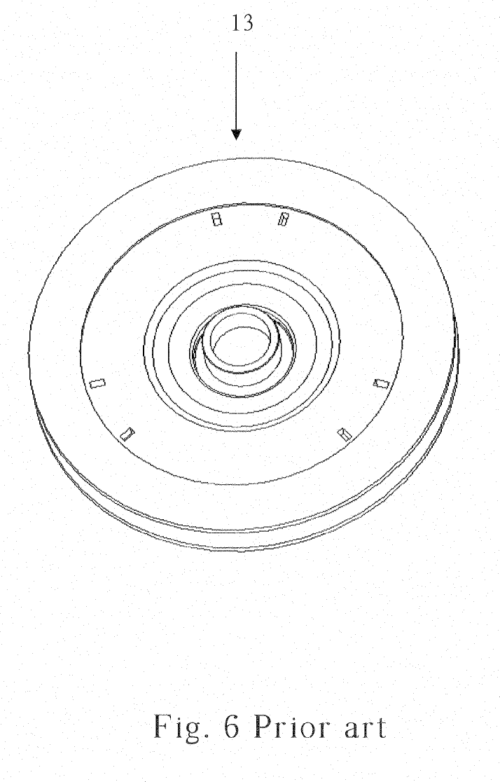

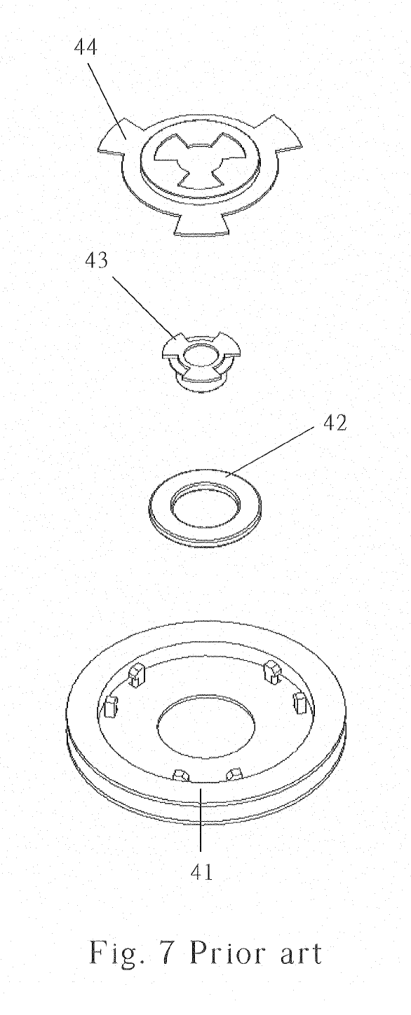

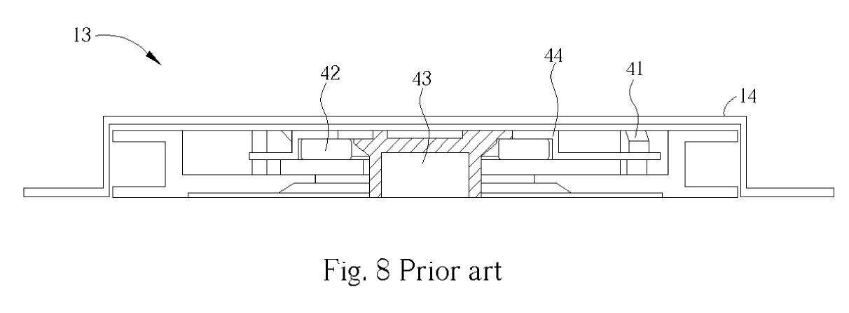

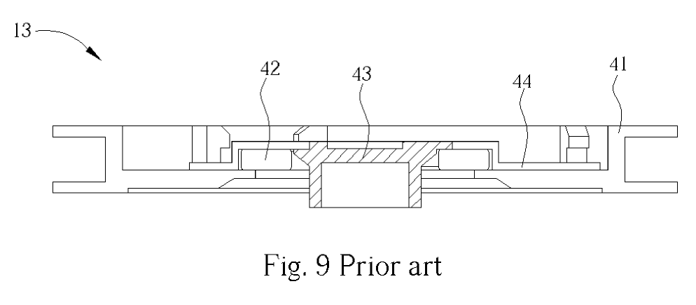

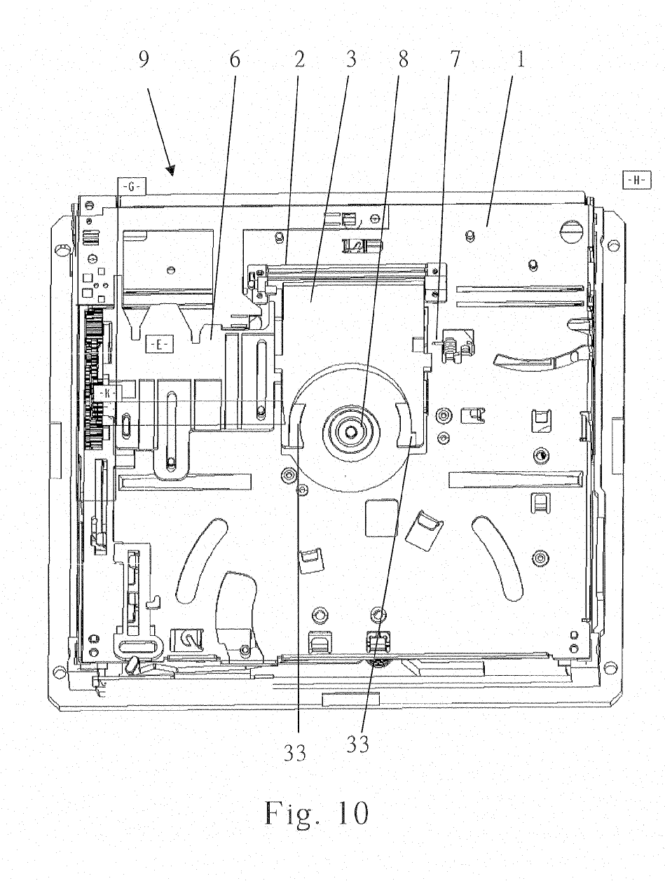

### DETAILED DESCRIPTION

The embodiments according to the present invention are related to a front-loading optical disk drive. Additionally, the present invention can be used in all kinds of optical disk drives including CD-ROM, CD-RW, half-height drives, combo drives, DVD-R/RW, external drives, optical players, and so on. Please note that elements with the same reference numerals are substantially the same through the various embodiments.

Please refer to FIG. 10. FIG. 10 is a diagram of an optical disk drive 9. The optical disk drive 9 includes a frame 1, a clamping holder fixer 2, a clamping holder 3, a rack-sliding element 6, an elastic element 7, and a turntable 8.

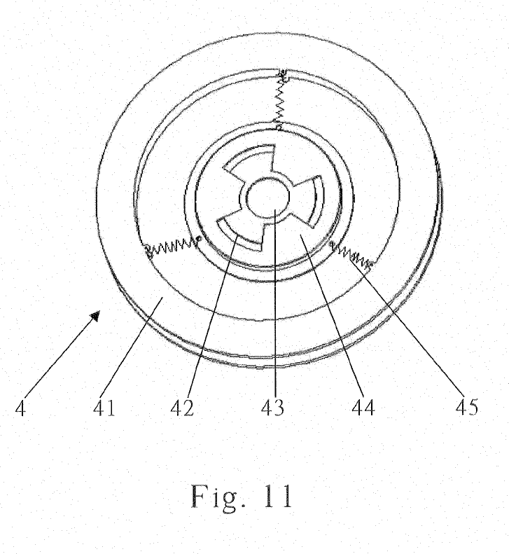

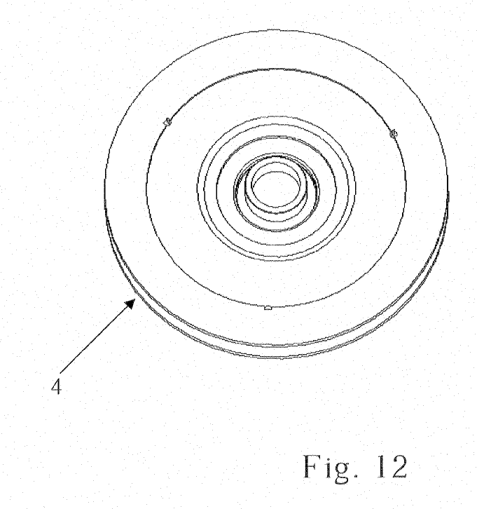

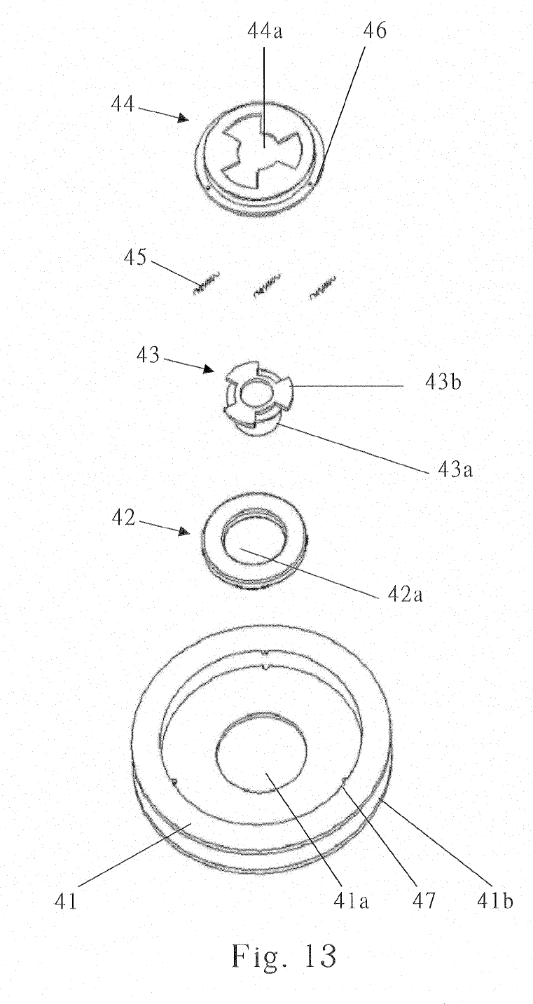

The clamping holder fixer 2 fixes the clamping holder 3 to the frame 1. The elastic element 7 applies a downward pressure to the clamping holder 3. The clamping holder 3 includes a clamping flange 33. Please refer to FIG. 11, FIG. 12, and FIG. 13. FIG. 11 is a top view of a floating-type clamping mechanism 4 according to a first embodiment of the present invention. FIG. 12 is a bottom view of the floating-type clamping mechanism 4 according to the first embodiment of the present invention. FIG. 13 is a perspective diagram of components of the floating-type clamping mechanism 4 according to the first embodiment of the present invention. The floating-type clamping mechanism 4 includes a clamping body 41, a magnetic element 42, a central clamping element 43, a clamping yoke 44, and a plurality of elastic elements 45. The clamping body is circular and includes a central hole 41a, a rabbet 41b on the edge, and a plurality of connecting holes. The magnetic element 42 includes a central hole 42a. The magnetic element 42 can be a magnet. The central clamping element 43 includes a prominent part 43a and an annular part 43b. The clamping yoke 44 includes a central hole 44a.

Please refer to FIG. 13. The annular part 43b of the central clamping element 43 passes through the central hole 44a of the clamping yoke 44, and the central clamping element 43 is installed on the clamping yoke 44. The central hole 42a of the magnetic element 42 holds the prominent part 43a of the central clamping element 43. Furthermore, the clamping yoke 44 further includes a plurality of connecting holes. The two ends of the plurality of elastic elements 45 are fixed to the connecting holes 46 and the connecting holes 47 individually.

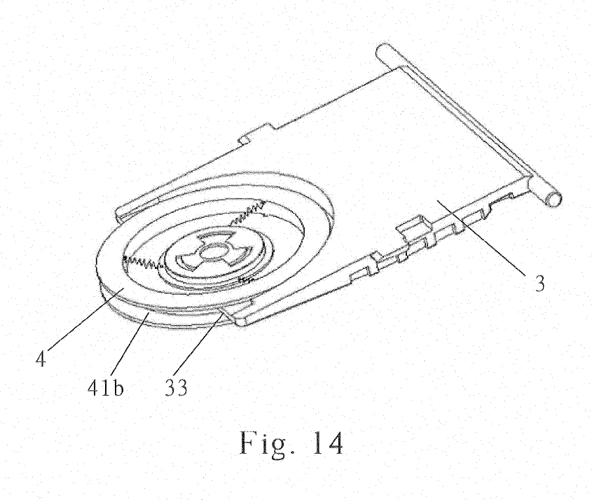

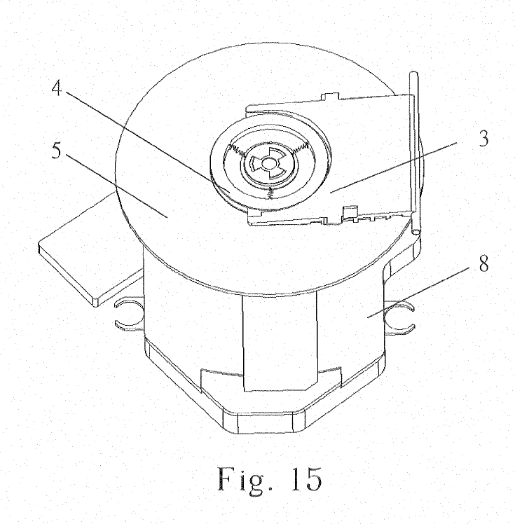

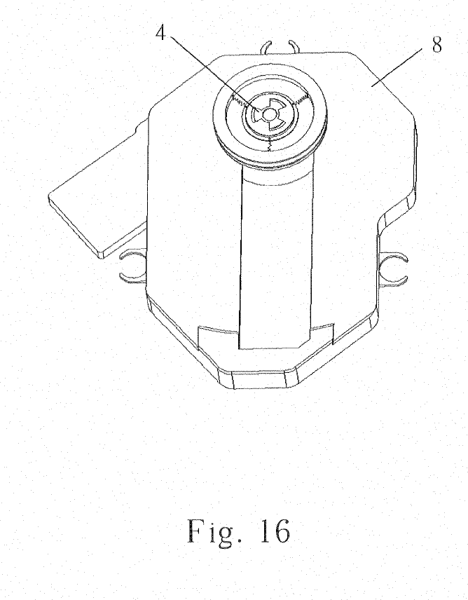

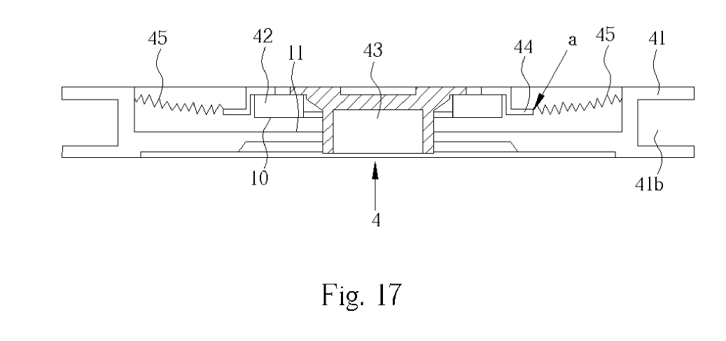

Please refer to FIG. 14, FIG. 15, and FIG. 16. FIG. 14 is a perspective diagram of the combination of the rabbet 41b of the floating-type clamping mechanism 4 and the clamping flange 33 of the clamping holder 3. FIG. 15 is a perspective diagram of the combination of the floating-type clamping mechanism 4 and the clamping holder 3 and the turntable 8 for fixing an optical disk 5 when the optical disk 5 is loaded into the optical disk drive 9. FIG. 16 is a perspective diagram of the combination of the floating-type clamping mechanism 4 and the turntable 8. As shown in FIG. 16, the clamping holder 3 and the optical disk 5 are removed. Please refer to FIG. 17. FIG. 17 is a schematic diagram of components of the floating-type clamping mechanism 4 when the optical disk 5 is not loaded into the optical disk drive 9. The magnetic element 42, the central clamping element 43, and the clamping yoke 44 are positioned at the upper location “a” by the elastic force of the plurality of elastic elements 45.

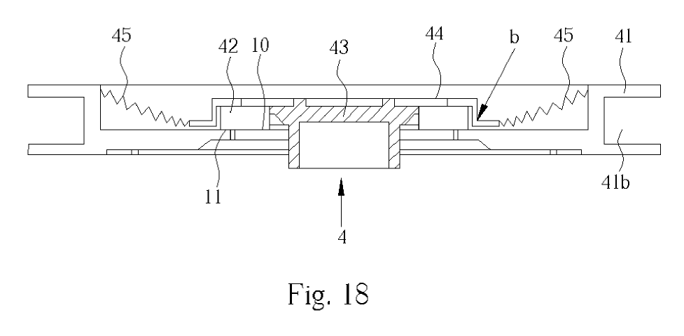

Please refer to FIG. 10 and FIG. 18. FIG. 18 is a schematic diagram of components of the floating-type clamping mechanism 4 when the optical disk 5 is loaded into the optical disk drive 9. When the optical disk 5 is loaded into the optical disk drive 9, the rack-sliding element 6 slides so that the inclining height difference of the rack-sliding element 6 and the downward pressure provided by the elastic element 7 can make the clamping holder 3 press the floating-type clamping mechanism 4 downward, and the magnetic element 42 of the floating-type clamping mechanism 4 and the magnetic element on the turntable 8 can attract each other. Therefore, the floating-type clamping mechanism 4 can fix the optical disk 5 more stably. As shown in FIG. 18, the magnetic element 42, the central clamping element 43, and the clamping yoke 44 are positioned at the lower location “b” by the attractive force of the magnetic element on the turntable 8, and a lower edge 10 of the magnetic element 42 contacts with an upper edge 11 of the inner annular part of the clamping body 41 and the prominent part 43a of the central clamping element 43 combines with the turntable 8 for fixing the optical disk 5. Moreover, the plurality of elastic elements 45 is stretched.

When the optical disk 5 is ejected from the optical disk drive 9, the clamping holder 3 can lift the floating-type clamping mechanism 4 to separate the magnetic element 42 of the floating-type clamping mechanism 4 from the magnetic element on the turntable 8. The lower edge 10 of the magnetic element 42 can be separated from the upper edge 11 of the inner annular part of the clamping body 41. The magnetic element 42, the central clamping element 43, and the clamping yoke 44 will go back to the upper location “a” in FIG. 17.

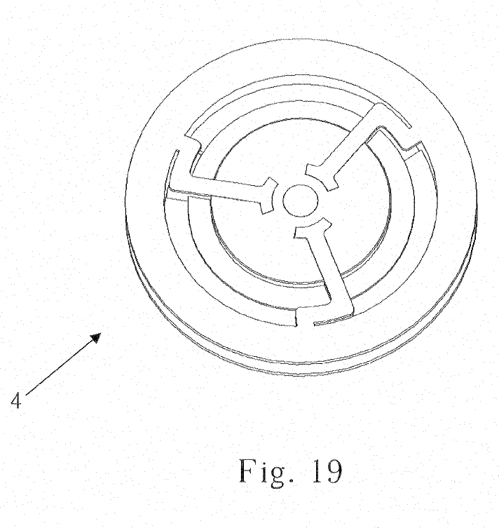

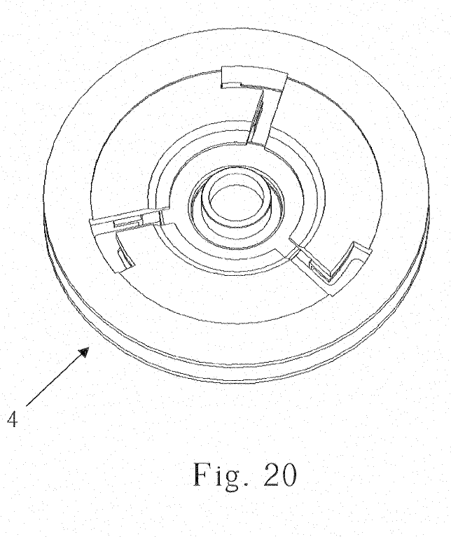

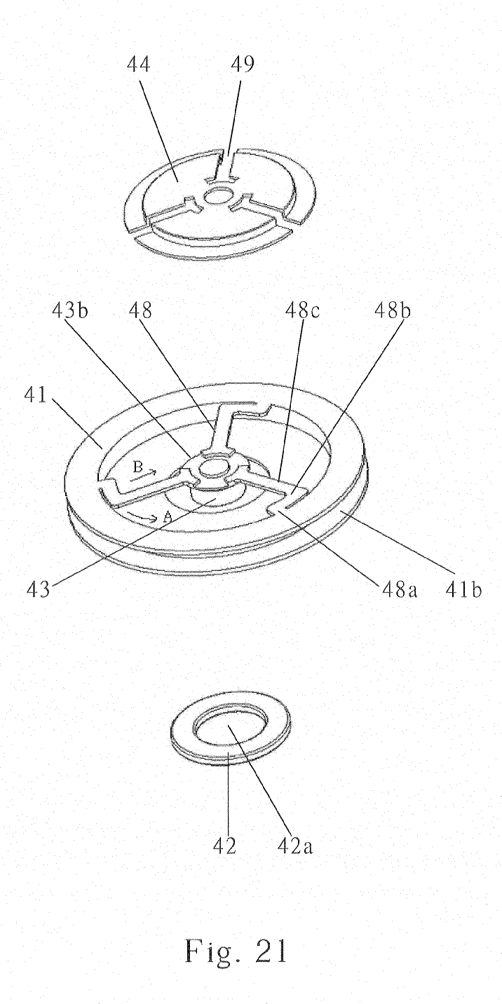

Please refer to FIG. 19, FIG. 20, and FIG. 21. FIG. 19 is a top view of a floating-type clamping mechanism 4 according to a second embodiment of the present invention. FIG. 20 is a bottom view of the floating-type clamping mechanism 4 according to the second embodiment of the present invention. FIG. 21 is a perspective diagram of components of the floating-type clamping mechanism 4 according to the second embodiment of the present invention. The floating-type clamping mechanism 4 includes a clamping body 41, a magnetic element 42, and a clamping yoke 44. The clamping body 41 is circular and includes a rabbet 41b on the edge, a plurality of cantilevers 48, and a central clamping element 43. Each of the plurality of cantilevers 48 is L-shaped, and a root 48a of each cantilever is fixedly connected to the outer annular part of the clamping body 41. An annular part 48b of the cantilever 48 stretches for a certain distance in a circumferential direction (A direction), and a radial part 48c stretches to the center of the clamping body 41 (B direction) and is fixedly connected to the central clamping element 43. The magnetic element 42 includes a central hole 42a and can be a magnet. The central clamping element 43 includes an upper annular part 43b. The clamping yoke 44 includes a plurality of notches 49 corresponding to the plurality of cantilevers 48. The clamping yoke 44 can be made of the material being attracted by the magnetic element 42. For assembly, first put the magnetic element 42 inside the clamping body 41 and above the upper annular part 43b of the central clamping element 43. Then, fixedly connect the upper annular part 43b to the plurality of cantilevers 48. And then cover the clamping yoke 44 above the magnetic element 42. Thus, the magnetic element 42 can attract the clamping yoke 44 according to the second embodiment.

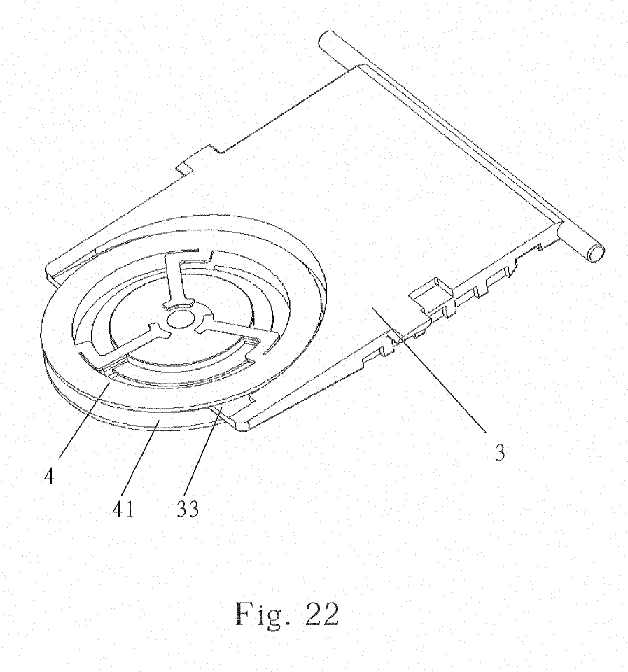

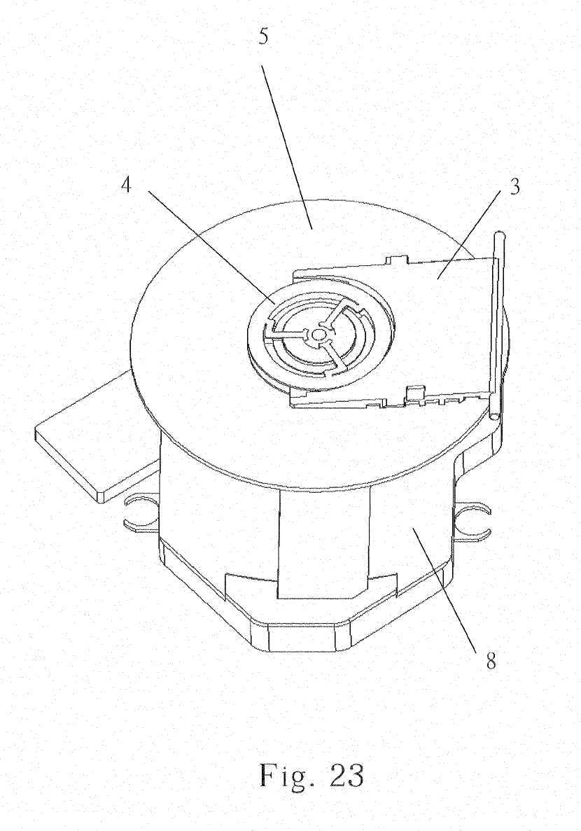

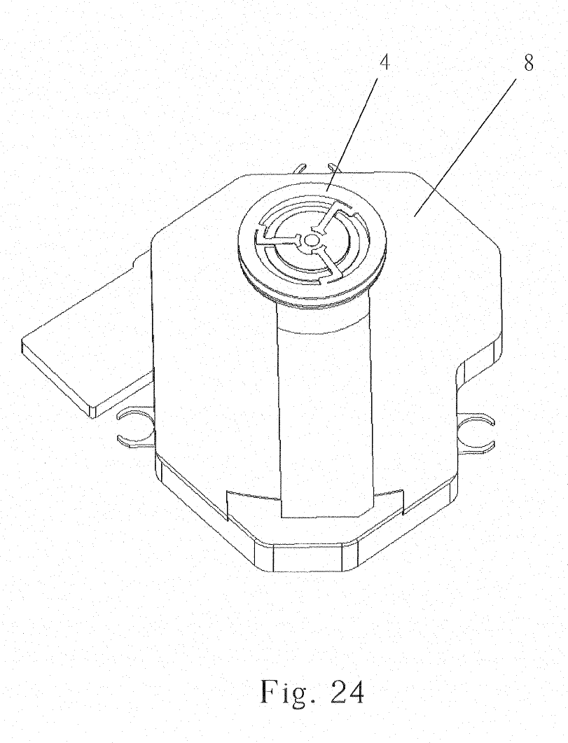

Please refer to FIG. 22, FIG. 23, and FIG. 24. FIG. 22 is a perspective diagram of the combination of the rabbet 41b on the outer edge of the floating-type clamping mechanism 4 and the clamping flange 33 of the clamping holder 3 according to the second embodiment of the present invention. FIG. 23 is a perspective diagram of the combination of the floating-type clamping mechanism 4 and the clamping holder 3 and the turntable for fixing the optical disk 5 when the optical disk 5 is loaded into the optical disk drive 9 according to the second embodiment of the present invention. FIG. 24 is a perspective diagram of the combination of the floating-type clamping mechanism 4 and the turntable 8 according to the second embodiment of the present invention. As shown in FIG. 24, the clamping holder 3 and the optical disk 5 are removed.

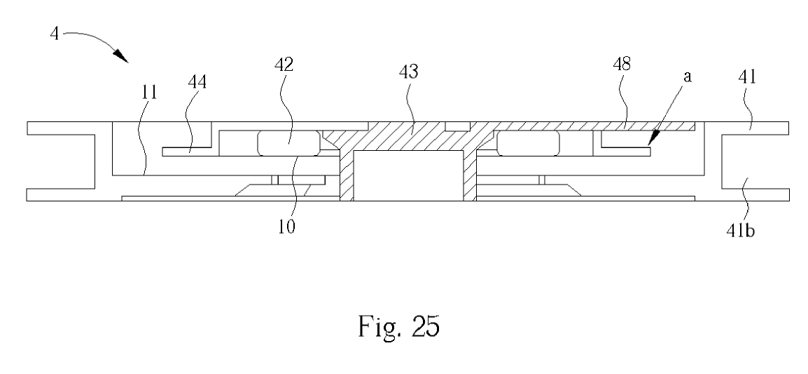

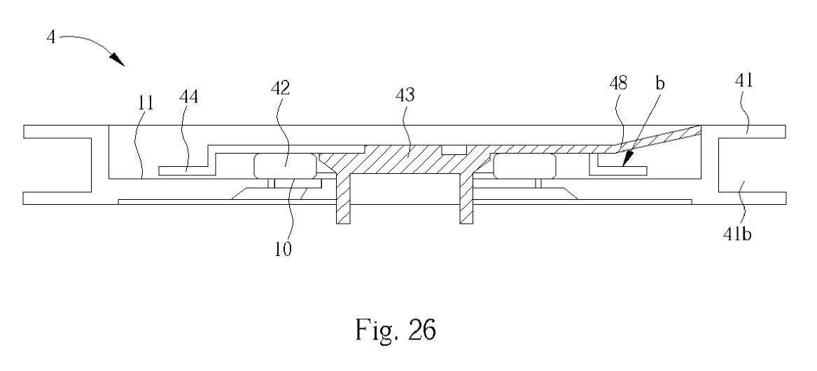

Please refer to FIG. 25. FIG. 25 is a schematic diagram of components of the floating-type clamping mechanism 4 when the optical disk 5 is not loaded into the optical disk drive 9 according to the second embodiment of the present invention. The magnetic element 42, the central clamping element 43, and the clamping yoke 44 are positioned in the upper location “a”. Please refer to FIG. 10 and FIG. 26. FIG. 26 is a schematic diagram of components of the floating-type clamping mechanism 4 when the optical disk 5 is loaded into the optical disk drive 9 according to the second embodiment of the present invention. When the optical disk 5 is loaded into the optical disk drive 9, the rack-sliding element 6 slides so that the inclining height difference of the rack-sliding element 6 and the downward pressure provided by the elastic element 7 can make the clamping holder 3 press the floating-type clamping mechanism 4 downward, and the magnetic element 42 of the floating-type clamping mechanism 4 and the magnetic element on the turntable 8 can attract each other. Therefore, the floating-type clamping mechanism 4 can fix the optical disk 5 more stably. At this time, the magnetic element 42, the central clamping element 43, and the clamping yoke 44 are positioned in the lower location “b” by the attractive force of the magnetic element on the turntable 8, and the lower edge 10 of the magnetic element 42 contacts with the upper edge 11 of the inner annular part of the clamping body 41 and the prominent part 43a of the central clamping element 43 combines with the turntable 8 for fixing the optical disk 5. In addition, the plurality of cantilevers 48 descends a certain distance. When the optical disk 5 is ejected from the optical disk drive 9, the clamping holder 3 can lift the floating-type clamping mechanism 4 to separate the magnetic element 42 of the floating-type clamping mechanism 4 from the magnetic element on the turntable 8. The lower edge 10 of the magnetic element 42 can be separated from the upper edge 11 of the inner annular part of the clamping body 41 by the restoring force of the plurality of cantilevers 48. The magnetic element 42, the central clamping element 43, and the clamping yoke 44 will go back to the upper location “a” in FIG. 25.

In contrast to the prior art, the floating-type clamping mechanism according to the present invention economizes the height of the limited inner space of an optical disk drive effectively. Furthermore, compared to the conventional attractive-type clamping mechanism, the floating-type clamping mechanism according to the present invention can reduce the cost and the height of the metal element, which the conventional attractive-type clamping mechanism attracts when the conventional attractive-type clamping mechanism is not loading an optical disk.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A floating-type clamping mechanism for use in an optical disk drive comprising:
a clamping body;
a clamping yoke comprising a first central hole;
a central clamping element for combining with the clamping yoke by passing through the first central hole;
a magnetic element comprising a second central hole for holding the central clamping element and combining with the clamping yoke; and
a plurality of elastic elements fixed to the clamping body and the clamping yoke.

2. The floating-type clamping mechanism of claim 1 wherein the magnetic element is a magnet.

3. The floating-type clamping mechanism of claim 1 wherein the clamping yoke further comprises a plurality of connecting holes and the clamping body comprises a plurality of connecting holes positioned correspondingly to the plurality of connecting holes of the clamping yoke and the plurality of elastic elements are connected to the plurality of connecting holes of the clamping yoke and the plurality of connecting holes of the clamping body.

4. The floating-type clamping mechanism of claim 1 wherein when an optical disk is loaded into the optical disk drive, the magnetic element of the floating-type clamping mechanism attracts a magnetic element on a turntable of the optical disk drive for fixing the optical disk, and when the optical disk is ejected from the optical disk drive, the magnetic element of the floating-type clamping mechanism separates from the magnetic element on the turntable of the optical disk drive and the magnetic element of the floating-type clamping mechanism separates from the clamping body by the elastic force of the plurality of elastic elements.

5. A floating-type clamping mechanism for use in an optical disk drive, the optical disk drive comprising a turntable, the floating-type clamping mechanism comprising:
a clamping body comprising a plurality of connecting holes;
a clamping yoke comprising a first central hole, and a plurality of connecting holes positioned corresponding to the plurality of connecting holes of the clamping body;
a central clamping element for combining with the clamping yoke by passing through the first central hole;
a magnetic element comprising a second central hole for holding the central clamping element and combining with the clamping yoke; and
a plurality of elastic elements wherein the two ends of each elastic element are fixed to the connecting hole of the clamping yoke and the connecting hole of the clamping body;
wherein when an optical disk is loaded into the optical disk drive, the magnetic element of the floating-type clamping mechanism attracts a magnetic element on the turntable of the optical disk drive for fixing the optical disk, and when the optical disk is ejected from the optical disk drive, the magnetic element of the floating-type clamping mechanism separates from the magnetic element on the turntable of the optical disk drive and the magnetic element of the floating-type clamping mechanism separates from the clamping body by the elastic force of the plurality of elastic elements.

6. The floating-type clamping mechanism of claim 5 wherein the magnetic element is a magnet.

7. A floating-type clamping mechanism for use in an optical disk drive comprising:
a magnetic element;
a clamping yoke for being attracted by the magnetic element; and
a clamping body comprising a central clamping element and a plurality of cantilevers connected to the central clamping element for holding the magnetic element and the clamping yoke.

8. The floating-type clamping mechanism of claim 7 wherein when an optical disk is loaded into the optical disk drive, the magnetic element of the floating-type clamping mechanism attracts a magnetic element on a turntable of the optical disk drive for fixing the optical disk, and when the optical disk is ejected from the optical disk drive, the magnetic element of the floating-type clamping mechanism separates from the magnetic element on the turntable of the optical disk drive and the magnetic element of the floating-type clamping mechanism separates from the clamping body by the restoring force of the plurality of cantilevers.
